(19) United States
(12) Patent Application Publication
(10) Pub. No.: US 2025/0011212 A1
(43) Pub. Date: Jan. 9, 2025

(54) Dispensing Apparatus For Producing and Dispensing Alkaline Water

(71) Applicant: Dmitrii V. Tateosov, Odintsovo (RU)

(72) Inventor: Dmitrii V. Tateosov, Odintsovo (RU)

(21) Appl. No.: 18/710,030

(22) PCT Filed: Oct. 3, 2022
(86) PCT No.: PCT/RU2022/000297

§ 371 Date: May 14, 2024

(30) Foreign Application Priority Data
Apr. 18, 2022 (RU) 2022110400

(51) Int. Cl. C02F 9/20; B01D 61/14; B01D 61/16; B01D 61/18; B01D 69/02; B01D 71/02; B67D 1/00; C02F 1/44; C02F 1/461; C02F 1/66; C02F 1/74; C02F 1/78

(52) U.S. Cl. CPC C02F 9/20; B01D 61/145; B01D 61/16; B01D 61/18; B01D 69/02; B01D 71/02; B67D 1/0014; B01D 2311/04; B01D 2325/20; B67D 2210/0001; B67D 2210/00018; B67D 2210/00023; C02F 1/444; C02F 1/4618; C02F 2001/4619; C02F 1/66; C02F 1/74; C02F 1/78; C02F 2201/4612; C02F 2301/043; C02F 2301/046; C02F 2303/04; C02F 2307/10

(57) ABSTRACT

The invention relates to the field of vending machines, and namely to vending apparatuses for dispensing purified water with specified properties to consumers. The apparatus for receiving and selling alkaline water consists of a water treatment unit, a water electrolysis unit with catholyte and anolyte lines, a control and monitoring unit, and a catholyte dispensing device. The apparatus is equipped with a water jet ejector. From the line of catholyte withdrawal from the electrolyzer there is provided a separate line of catholyte supply to the water purification unit, with the connection to the technological elements of this unit before the ultrafiltration device for realization of alkaline medium in this device.

### FIELD OF THE TECHNOLOGY

The invention relates to the field of vending apparatuses, and in particular relates to vending apparatuses for supplying consumers with purified water having predetermined properties.

### DISCUSSION OF THE PRIOR ART

Currently, there are known water vending apparatuses for water purification, wherein the properties are regulated and water being prepared for sale. Typically, these are dispensing apparatuses having water disinfection and purification units and a bottling water dispensing unit.

For example, there are widely used vending apparatuses for the retail sale of bottled water, which have a cleaning and disinfection system [Commodity offer “Living Water” [Electronic resource]—https://alivewater.ru/kataloq/apparaty-pitevoi-vodv]. The disadvantages of these apparatuses are the lack of ability to regulate the properties of water, including its pH, and limited options for dispensing water to consumers.

There is also known a vending apparatus for the retail sale of water, using coarse and fine filters, as well as an electrolysis device with a silver electrode. It makes it possible to obtain silver water with a given concentration of silver ions [Russian Patent No 2495496]. The disadvantage of this apparatus is the inability to obtain alkaline water (water with pH>8).

A major problem for obtaining alkaline water is also the purification of the source water from organic impurities. To solve this issue, it is known to use a method comprising the decomposition of organic compounds of wastewater with ozone in the near-cathode space saturated with hydroxyl ions, i.e. in an alkaline environment [Japanese Patent Publication PCT/EP2005/051629].

The essence of the method is to bubble ozone through wastewater into which DC electrodes are lowered. The disadvantages of this method and design are as follows: low productivity due to contamination of the electrodes with decomposition products and the complexity of additional placement of such equipment due to the need to increase the technological volume of the dispensing apparatus.

It is known from the scientific literature that the oxidation of organic impurities in water occurs more intensely in an alkaline environment. It is likely that this occurs due to the effect of the ozonide ion—O₃, which is the strongest oxidizing agent and is formed during the decomposition of ozone in an alkaline environment [B. F. Kozhinov, I. V. Kozhinov. Ozonization of water. [Electronic resource].—URL: https://helpiks.org/2-71562.html], on organic compounds. This property provides ozone with a high ability to oxidize organic water contaminants in an alkaline environment [Ozone oxidation. [Electronic resource]—URL: https://ru-ecology.info/term/.].

It was previously discussed an example of purification from organic contaminants of wastewater in an alkaline environment [Japanese Patent Publication PCT/EP2005/051629.]. However, the data presented in these sources is only of a scientific, fundamental nature, and does not allow to put into practice the pattern of increased oxidation of organic compounds by ozone in an alkaline environment.

There is also known a water vending apparatus having pre-filtration and ultra-fine water filtration devices, an electrolyzer for water treatment, with storage tanks for cationite—alkaline water and anolyte—acidic water, which have water inlet and outlet for consumers, as well as a control system including touch screen control.

A membrane type filter was used as a pre-filtration filter to separate mechanical impurities. For further purification of water before the electrolyzer, a filter is used with activated carbon and KDF catalytic powder, which is an ultrafine filtration device [Chinese Patent Publication No 201910570779.3].

The disadvantage of this apparatus is the absence of a device for disinfecting the water entering the apparatus and the impossibility of obtaining and dispensing alkaline water with the specified parameters.

The closest prior art known to the inventor and related to the present invention is an apparatus for producing and selling/dispensing alkaline water, consisting of: a water purification unit, including pre-filtration and ultrafine water filtration devices, a water electrolysis unit with catholyte and anolyte removal, a control system unit with a software device, as well as catholyte and anolyte dispensing devices with their input and output.

The water treatment unit has a disinfection arrangement with a recirculation line. It also includes a bypass line parallel to the treatment line, and allowing to supply or to add to the electrolyzer the purified water, as well as to dispense water having a predetermined degree of purification.

Water electrolysis unit allows to set and maintain a given value of catholyte pH, due to the coordinated regulation of the current strength of the electrolysis process on the corresponding devices, as well as water consumption during the separation and selection of a dosed portion of catholyte at the outlet of the electrolyzer.

At the outlet of the electrolyzer there is an anolyte output line and a catholyte line, directing it to be dispensed to the consumer, the control and monitoring unit, contains a processor unit and sensors for realization of parameters of the dispenser operation, and the catholyte dispenser contains:
supply of the dispensing line and the dispensing window for bottling with dispensing and/or dosing and/or partial cutting/restriction equipment, while the dispensing line is made of materials deactivated with respect to hydroxide ions;
at least one window and one line for dispensing bottles of water and/or accessories [Russian Patent No 2758347]. It should be noted that in this invention/disclosure as a pre-filtration device there are used devices with a filter membrane having the pore size which varies in the range between 0.1 and 0.01 microns. It should be noted that in the present invention, a filter membrane having a pore size varying between 0.1 and 0.01 microns is used is used as a pre-filtration device. In this case, the filter membrane can be called an ultrafiltration membrane, and the pre-filtration device can be called an ultrafiltration module or ultrafiltration device.

The disadvantage of the above-described apparatus is the insufficient level of purification of water from organic impurities at the pre-filtration stage, which in turn leads to the increase in the time and number of the preventive measures for cleaning the membranes of the pre-filtration device itself, as well as the ultra-fine purification device and electrolyzer.

### Problems to be Solved and Technical Results to be Achieved by the Present Invention

The problem to be solved by the claimed invention is to eliminate the shortcomings of the above-discussed technical solution and to achieve a technical result for increasing the degree of water purification from organic impurities at the ultrafiltration stage, as well as to expand the arsenal of technical means of automatic apparatuses for obtaining and dispensing water.

### DISCLOSURE OF THE INVENTION

Achieving the specified technical result in the claimed invention is achieved through the implementation of the automatic apparatus for the production and sale of alkaline water, consisting of a water purification unit, including a disinfection device with a recirculation line, an ultrafiltration device, an ultrafine purification device and a bypass line positioned parallel to the purification line and allowing the supply or add to the electrolyzer.

The apparatus also dispenses water with a given degree of purification and includes a water electrolysis unit with removal (output) of catholyte and anolyte, which allows a user to set and maintain a given pH value of the catholyte. This occurs due to the coordinated regulation of the amperage of the electrolysis process at the appropriate devices, as well as due to the flow rate water when isolating and selecting a dosed portion of catholyte at the outlet of the electrolyzer. At the outlet of the electrolyzer there is provided an anolyte output line and a catholyte line directing the catholyte to the consumer, a control and monitoring unit containing a processor unit and sensors for implementing the operating parameters of the apparatus.

At the same time, to supply purified water to the inlet compartment of the ultrafiltration device a water-jet ejector is provided, through which an ozone-air mixture is simultaneously supplied to ozonate such water. From the catholyte output line from the electrolyzer, a separate catholyte supply line is provided to the water purification unit with connection to the technological elements of this block before the ultrafiltration device to ensure an alkaline environment in this device.

For an unambiguous and more complete understanding of the description of the claimed invention, further clarifications and disclosures of the concepts and terms used above, as well as a description of the construction, are given below.

One of the major goals of the vending apparatus of the invention is to automatically produce and sell alkaline water with pH values from 8.0 to 11.0. Such water can be used for various needs in various areas of the economy and primarily for medical purposes, in traditional medicine, and for other health-related purposes.

Since in the claimed invention the production of alkaline water is carried out using an electrolytic process in the cathode space, this water can be also called catholyte. Thus, the concepts of catholyte and alkaline water in this presentation are almost identical. On the other hand, in the electrolytic process, anolyte or acidic water is obtained in the anode space. Such water can also have wide applications, particularly in medicine.

Clean, sanitized water is required for health improvement purposes, therefore the claimed invention provides a purification unit comprising technologically linearly arranged devices for disinfection, pre-filtration or ultrafiltration, and ultrafine purification.

Disinfection is mainly carried out by ozonation. Ozonation is carried out in a contact container into which an ozone-air mixture is supplied from an ozone generator. The supply is carried out mainly through a water-jet ejector. A recirculation line is additionally connected to the ozone supply line to the contact tank for better mixing of ozone with the source water.

This line is located between the water outlet and water inlet of the contact tank. In the invention, the disinfection by ozonation also includes the simultaneous oxidation of organic and organochlorine impurities. The contact container can also serve as a storage container.

From the contact tank, water with oxidation products of organic and organochlorine impurities is sent to the ultrafiltration device. It should be noted that is often difficult to achieve the complete oxidation of organic and organochlorine impurities.

Therefore, water is supplied from the contact tank to the ultrafiltration device through a water-jet ejector with the supply of an ozone-air mixture. It is known from practice that the use of the ejectors for supplying gas-liquid mixtures is more effective the productivity purposes and the level of mixing than other commonly known methods, which include parallel supply of gas and liquid components or bubbling.

The ultrafiltration device is typically a filter with a fine-porous membrane having a pore size which varies in the range between 0.01 and 0.1 μm. The conditions for filtration are as follows: differential pressure in the range of 0.05-0.6 MPa, flow rate of the ozone-air mixture through the ejector in the range of 8×10⁵-56×10⁵ m³/s (0.3-2 m³/hour), filtration surface area in the range of 0.15-2 m², the content of dissolved ozone in the mixture is in the range of 0.01-1 g/m³.

During filtration, oxidation products of organic and organochlorine impurities may accumulate in the inlet compartment of the ultrafiltration device. These products can clog the pores of the ultrafiltration membrane interfering with the filtration process.

To avoid this, a liquid supply line is organized from the inlet compartment to the contact tank, which is equivalent to organizing a second recycling line into the contact tank. Recycling can be accomplished by partially activating the bypass line.

Recycling reduces contamination of the surface of the ultrafiltration membrane. To regulate the pressure in the inlet compartment of the filter, a throttle can be installed in the recycling line (the second recycling line—the line for returning the filtered liquid to the contact tank). A drain can be provided to remove contaminants from the system.

The filtrate from the ultrafiltration device is fed to the ultrafine purification device. The ultrafine purification device is typically a reverse osmosis filter. It is also possible to organize the return of filtered water through bypass devices back through the system and drainage of contaminants. The differential pressure in the filter is 0.4-2 MPa, the filtration surface area is in the range of 0.15-2 m².

The present invention takes into account the data on enhancing the oxidizing capacity of ozone in an alkaline environment, in the review of the state of the art. According to the invention, an alkaline environment in the inlet compartment of the ultrafiltration device is created by introducing there the catholyte obtained in the electrolyzer as a product for the intended purpose.

For this purpose, the apparatus for receiving and dispensing the alkaline water has an additional separate pipeline line connecting the outlet from the cathode space of the electrolyzer with the technological elements of the water purification unit located before of the ultrafiltration device.

These technological elements can be a contact tank, an entrance to a contact tank, and/or a recycling line. Thus, the catholyte also has a secondary technological function. The additional separate pipeline line ensures the implementation of this function, which makes it possible to increase the degree of water purification from organic impurities at the ultrafiltration stage.

This separate pipeline line may have shut-off and control valves at both ends, whereas on the side of connection to the technological elements of the water purification unit it has an inlet device. This inlet device can be configured as an ejector, a pipe or an injector.

Parallel to the above-mentioned purification process line, there is provided an auxiliary process line-a bypass, which is connected to the main process line in the process units between the purification stages, before the electrolyzer and, if necessary, after the electrolyzer.

If necessary, depending on the composition of the source water, the described purification line can be supplemented with de-ozonation devices, a pump, measuring and control devices and sensors, and hydraulic accumulators. If additional ozone removal is necessary, carbon adsorbents are used.

The housings of the cleaning unit devices and pipelines, as well as additional devices, are mainly made of stainless steel, polymer, and metal-polymer materials.

Purified water enters the electrolysis unit, where it is electrolytically processed, while the water in the near-electrode areas is converted into catholyte and anolyte or alkaline and acidic water.

Electrolysis is carried out to certain, specified pH values. Typically, these are values in narrow pH ranges, which can be between 0.1 and 0.4 pH.

For example, for retail sale of alkaline water, water with pH values from 9.4 to 9.8 is used. The general range of adjustable pH values is from 8.0 to 11.0.

Providing alkaline water with specified pH values in the range from 8.0 to 11.0 is a difficult task due to the low stability of hydroxide ions in slightly and moderately alkaline aqueous media, as well as due to interaction with active internal surfaces and impurities. This situation leads to the need to implement a special regime for monitoring and regulating the electrolysis process.

In practice, during periodic operation of the apparatus of the invention, such control and regulation is carried out when dispensing each portion, and during continuous operation, after a certain time or a certain number of dispensed portions of catholyte. Therefore, the electrolysis unit is equipped with a control system, which is equipped with sensors for water input and flow, sensors for current strength and, of course, a pH measuring device.

Based on the readings of the process sensors and the set pH values, the consistent process parameters are determined. Such parameters, first of all, are the electrical current strength of the electrolysis process and the amount of water supply flow (water flow) at the entrance to the electrolyzer, as well as the purity of the water at the entrance to the electrolyzer. The parameters are consistent with each other, because changing of one parameter leads to changing the other.

For example, an increase in the pH value of the catholyte can be achieved both by reducing water consumption and by increasing the electrical current of the process or by compensatory changes in both parameters. Similarly with respect to the purity of the water fed to the electrolysis process-increasing purity leads to the possibility of lowering the amperage.

In the practical operation of the apparatus of the invention, in many cases it is convenient to establish and maintain a given pH in portions. This is accompanied by turning on the electrolyzer and supplying the required amount of water to the input of the electrolyzer are carried out in concert after payment, whereas the portion of water is generated after the specified pH value is reached in the catholyte.

In this way, the catholyte with the predetermined parameters is provided/isolated, and then the required portion in the provided catholyte is selected. The selected portion is delivered to the consumer. In these cases, the pH is increased by carrying out the electrolytic process at a constant flow of water.

It should also be clarified that water approaches the electrolyzer along one line-along the input line. However, when entering the electrolyzer this main flow is divided into two: one is sent to the cathode space, and the other to the anode space.

In this case, the flow of incoming water can be regulated both on the common supply line to the electrolyzer and on the branch lines to the cathode and/or anode spaces.

Regulation of the electrolysis process current and water consumption (flow) is carried out by the appropriate devices. To regulate the electrical current, in particular, rheostats or thyristor regulators are used; to regulate the water flow, for example, ball or needle valves with a mechanical drive, and electromagnetic valves are used.

Parts of the electrolyzer, including the body and electrodes, are made mainly of stainless materials; the materials used for the partitions between the electrode spaces are typically fine-pored ceramics.

The anolyte is removed from the anode space of the electrolyzer through a separate line and sent to the sewer or the storage tank. In particular, anolyte from a storage tank can also be used for washing or disinfecting individual devices of the apparatus of the invention. The catholyte is removed from the cathode space through a separate line and sent for distribution to the consumer.

The catholyte is dispensed on tap in a window specially equipped for this purpose. It can be also dispensed in bottles with an internal decontaminated surface in another window. In the same or another (third) window, it is also possible to dispense/sell various accessories. Catholyte can be bottled according to several alternatives:
normal dispensing by stream through the equipment of the apparatus, in particular through a tap provided with shut-off valves;
portioned dispensing via tap; and
dispensing with cutting off the initial portion-used at a low pH value of the initial portion.

The dispensing equipment is typically made of stainless steel or polymer materials with decontaminated internal surfaces.

The control and monitoring unit contains a processor unit and sensors for implementing the operating parameters of the apparatus. The operation of the apparatus for receiving and dispensing water is monitored using numerous sensors.

The data received from the sensors is processed in the processor unit using a special program, as a result of which commands are sent to the appropriate control and/or execution devices. Executed commands carry out and support the process of operation of the apparatus, which is ultimately implemented after payment into the dispensing of a certain amount of alkaline water of a given pH value.

The catholyte dispensing device solves the problem of maintaining a given alkalinity during dispensing due to the rapid organization of dispensing and the use of materials deactivated with respect to hydroxide ions. Typically, stainless steel is used as the material for tubes and pipes of the dispensing device, as well as dispensing containers. Reducing the dispensing time is accomplished by shortening the dispensing path and electrolysis time.

Distinctive from the prior art, essential features of the present invention or their characteristics are as follows:
implementation of a water-jet ejector for supplying purified water to the inlet compartment of the ultrafiltration device, while simultaneously treating such water with an ozone-air mixture;
providing a separate catholyte supply line from the catholyte output line from the electrolyzer to the water purification unit with connection to the technological elements of the unit before the ultrafiltration device to ensure an alkaline environment in this device.

The given essential features are distinctive from the prior art because each of them is not contained in the totality of essential features of the prototype, i.e. is not present in the list of features implemented in the prior art and is not their characteristic.

It was shown above that the indicated essential features, distinctive from the prior art, ensure the achievement of the declared technical result when using other essential features of the invention specified in the description.

Thus, it is shown that the set of essential features of the claimed invention, which makes it possible to achieve the declared technical result, differs from the set of essential features of analogue prior art, as well as other known sources of data, i.e. the use of this set of essential features to obtain the stated technical result is not known. In other words, the claimed invention is not known from the prior art.

While studying the level of technology of automatic apparatuses for controlling the dispensing of liquids, devices for preparing drinks, as well as apparatuses for obtaining and dispensing alkaline water, no technical solutions were identified, the essential features of which, individually or in any combination, coincide with the distinctive essential features of the claimed invention and allow achieve the claimed technical result.

Thus, the lack of knowledge of the influence of the distinctive essential features of the claimed invention on the claimed technical result has been confirmed.

It should also be noted that the use of the entire declared set of essential features, including the set of distinctive features, to obtain the declared technical result is not obvious to specialists from the prior art, since it does not constitute a combination, modification or sharing of the information contained in the level of technology, and/or general knowledge of a specialist.

Indeed, the organization/execution of a line for draining part of the catholyte from the electrolyzer, which is connected via a separate line to the water purification unit and this connection is located before the ultrafiltration device for the implementation of an alkaline environment in this device, does not follow clearly from the prior art for specialists through the use of technical solutions, which are listed above as essential features different from the prior art.

Thus, regarding the confirmed achievement of the stated technical result, a non-standard and unknown technical solution are:
implementation of a water-jet ejector for supplying purified water to the inlet compartment of the ultrafiltration device with simultaneous processing of it with an ozone-air mixture,
providing a separate catholyte supply line from the catholyte output line from the electrolyzer to the water purification unit with connection to the water treatment technological elements before the ultrafiltration device to ensure an alkaline environment in this device.

These distinctive essential features should be considered in conjunction with the use of other disclosed essential features.

An increase in the efficiency of the declared technical result is achieved in the following modifications of the apparatus, which characterizes special cases of its implementation:
1. The automatic apparatus of the invention for the production and dispensing of alkaline water, characterized in that the disinfection device is a contact container into which the ozone-air mixture is fed through a water-jet ejector.
2. The automatic apparatus of the invention for the production and sale of alkaline water, characterized in that the ultrafiltration device contains a ceramic filtration membrane with a cutoff threshold of 0.1-0.01 microns.
3. The automatic apparatus of the invention for obtaining and dispensing alkaline water, characterized in that the supply line to the bottling window, as well as the dispensing and/or dosing equipment are made of stainless steel.
4. The apparatus of the invention for the production and sale of alkaline water, characterized in that the supply line to the bottling window, as well as the dispensing and/or dosing equipment, are made of materials with a deactivated inner surface relative to hydroxide ions.
5. The apparatus of the invention for obtaining and dispensing alkaline water, characterized in that there is one window located at the front panel of the apparatus for dispensing bottles of water and accessories.
6. The apparatus of the invention for obtaining and dispensing alkaline water, characterized in that different windows located at the front panel of the apparatus are intended for dispensing bottles of water and accessories.
7. The automatic apparatus of the invention for obtaining and dispensing alkaline water, characterized in that the connection of the catholyte supply line to the technological elements of the water purification unit is made as an ejector, or branch pipe or injector.

### BRIEF DESCRIPTION OF THE DRAWING

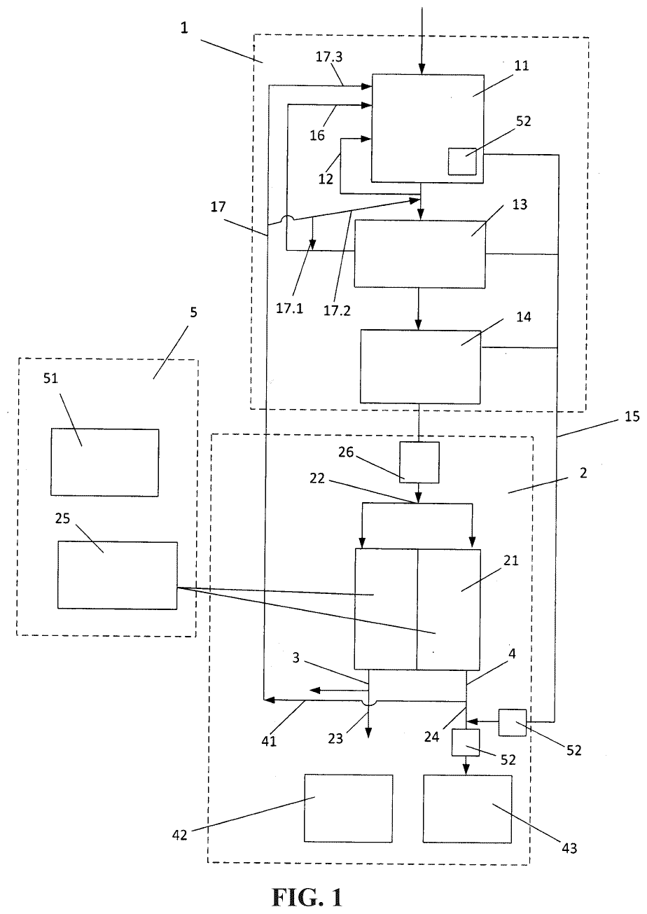

The description of the method of the invention is illustrated in a diagram of FIG. 1 wherein the following elements are shown:
1—water purification unit,
11—disinfection device with contact tank,
12—recirculation line,
13—ultrafiltration unit,
14—ultra-fine purification unit or reverse osmosis filter,
15—bypass,
16—second recycling line via bypass,
17—input unit for the catholyte line in the water purification unit,
17.1, 17.2, 17.3—embodiments for connecting the catholyte line of the input unit in the water purification unit,
2—electrolysis unit,
21—electrolyzer,
22—water inlet into the electrolyzer,
23—anolyte yield,
24—catholyte output,
25—current regulator in the electrolyzer,
26—water flow regulator at the inlet to the electrolyzer,
3—anolyte line,
4—catholyte line,
41—line for catholyte output from the electrolyzer to the water purification unit,
42—catholyte dispensing window
43—window for dispensing bottles with catholyte or accessories,
5—control and monitoring unit,
51—processor unit,
52—control sensors

### DESCRIPTION OF THE EMBODIMENTS OF THE INVENTION

The present invention disclosing “An apparatus for obtaining and dispensing alkaline water,” is implemented in the following manner.

The apparatus for producing and dispensing alkaline water consists of a water purification unit 1, an electrolysis unit 2, an anolyte line 3, a catholyte line 4, a control and monitoring unit 5. The water purification unit is designed to purify source water before electrolytic treatment and contains a disinfection device with a contact container 11, as well as a recirculation line 12, an ultrafiltration device 13, an ultrafine purification device, mainly a reverse osmosis filter 14, a bypass 15, a second recycling line 16. The ultrafiltration device also contains a device for entering or connecting the catholyte line to the technological elements of the water purification unit 17. Line connections catholyte can be implemented in various ways, for example:
to the second recycling line,
into the supply line in front of the ultrafiltration device 17.1,
into a disinfection device.

Initially, water is disinfected by ozonation.

The required degree of disinfection at this stage is achieved by means of recycling. The ozone-air mixture is introduced into the contact container, mainly through an ejector. Then ultrafiltration from impurities and finally ultrafine filtration are carried out.

The bypass line allows a user to flexibly rearrange the purification scheme depending on the composition of the source water and intermediate filtrates, and also allows to partially regulate the water output. Part of the bypass line can be used as a second line for recycling filtered water into the contact tank.

The electrolysis unit contains electrolyzer 21 equipped with an inlet for water 22. After this inlet, the water flow is divided into two streams, one is sent to the cathode space, and the other to the anode space of the electrolyzer. Anolyte and catholyte exit from the anode and cathode spaces of the electrolyzer, respectively, along lines 3 and 4.

From the catholyte output line from the electrolyzer, a catholyte outlet line extends to the water purification unit 41. The specified anolyte and catholyte output lines are equipped with devices 23 and 24 for dispensing these products to the consumer. The electrolyzer also contains devices for regulating the current strength 25 and the amount of water flow at the inlet 26.

In the electrolyzer, water is decomposed to form anolyte and catholyte with specified pH values. One of the electrolyzer outlets is the beginning of the catholyte line, and the other is the beginning of the anolyte line. The anolyte is sent to the drain or into some storage tank, and the catholyte line is sent to the consumer.

At the end of the catholyte line, the front panel has a catholyte dispensing window 42 and a catholyte bottle or accessory dispensing window 43. The control and monitoring unit contains a processor unit 51 and monitoring sensors 52 distributed at the monitoring points.

### Example 1

To obtain alkaline water with pH values from 9.4 to 9.8, an automatic apparatus is used, which consists of a water purification unit, an electrolysis unit, an anolyte line, a catholyte line, a control and monitoring unit. The apparatus is connected to the water supply and the water supply is turned on. The water had the following characteristics: pH 7.5-7.8, iron content in the range from 0.3 to 0.5 mg/l, manganese content in the range from 0.1 to 0.2 mg/l, permanganate oxidation in the range from 5 to 7 mg/l, presence of traces of chlorine and organochlorine compounds.

The water entered the water purification unit, where it was purified and disinfected by being treated with an ozone-air mixture using an ejector and by means of recirculation of the ozonized water flow. Then the water was purified using an ultrafiltration device with a pore size in the range of 0.01-0.1 microns, and then using a reverse osmosis filter.

Ultrafiltration membrane tubular design, surface area of filtration 1.0 m². The design of all reverse osmosis membranes is the same. It consists of a fabric wound in the form of a roll; the filtration area of a four-inch reverse osmosis membrane is 8 m². In this case, the differential pressure on the ultrafiltration membrane was 0.05-0.06 MPa, and on the reverse osmosis membrane 0.4 MPa.

Purified water with the following characteristics: pH 7.5-7.8, iron content 0.01-0.015 mg/l, manganese 0.01-0.015 mg/l, permanganate oxidation 0.01-0.012 mg/l, with the absence of chlorine and organochlorine compounds entered the inlet of an electrolyzer with a working volume of 1 liter.

In the electrolyzer water was subjected to electrolytic treatment according to a periodic technological scheme, i.e. with periodically dosed supply of water to the inlet of the electrolyzer and flexible coordinated regulation of the parameters of the electrical current strength and volume of water supply. The above is provided to maintain a predetermined pH value in the catholyte at the outlet of the electrolyzer.

In this case, the current was 5-8 A, the water supply volume was from 0.3 to 0.5 m³/hour, and the pH at the outlet of the electrolyzer was from 9.4 to 9.8. The catholyte with the specified pH value was supplied to consumers in bulk. Bottling was carried out in the amount of payment made by the consumer into stainless bottles.

To maintain constant cleaning and electrolysis parameters, the inlet compartment of the ultrafiltration device and its membranes are cleaned once every 3 months.

### Example 1.2

The implementation of the apparatus for obtaining and dispensing water with pH values from 8.0 to 8.4 was carried out similarly to Example 1. But in contrast with Example 1, a separate catholyte supply line was provided between the catholyte output line from the electrolyzer and the water purification unit. The connection of this line is made by connecting such line to the main line for recirculation of the ozonized flow into the contact vessel.

The water entering the apparatus had the following characteristics: pH 6-6.5, iron 0.1-02 mg/l, manganese 0.05-0.07 mg/l, permanganate oxidation 3-3.5 mg/l, and without chlorine and organochlorine compounds, was supplied to the input of an electrolyzer with a working volume of 1 liter. In the electrolyzer, water was subjected to electrolytic treatment according to a periodic technological scheme, i.e. with periodic dosed water supply to the electrolyzer inlet and flexible coordinated regulation of the parameters of the electrical current strength and water supply volume in order to maintain a given pH value in the catholyte at the electrolyzer outlet.

In this case, the electrical current strength was 3-5 A, the water supply volume was from 0.5 to 0.8 m³/hour, and the outlet pH was from 8.0 to 8.4. The catholyte with the specified pH value was supplied to consumers in bulk. Dispensing/Bottling was carried out in the amount of payment made by the consumer into stainless bottles. To maintain constant cleaning and electrolysis parameters, the inlet compartment of the ultrafiltration device and its membranes were cleaned once every 4 months.

### Example 2

The implementation of the apparatus for the production and sale of water with pH values from 8.0 to 8.4 was carried out similarly to Example 1. However, the filtration surface area was 2 m². In this case, the differential pressure on the ultrafiltration membrane was 0.6 MPa, and on the reverse osmosis membrane 2 MPa, the differential pressure value was 0.20-0.25 MPa.

The water entering the apparatus had the following characteristics: pH 6.5-6.8, iron 15-18 mg/l, manganese 6-7 mg/dm³, permanganate oxidation 10-13 mg/l, with the presence of traces of chlorine and organochlorines substances.

The water entering the electrolyzer had the following characteristics: pH 6.5-6.8, iron 0.01-0.015 mg/l, manganese 0.01-0.014 mg/l, permanganate oxidation 1-1.5 mg/l, with the absence of chlorine and organochlorine compounds. Electrolytic treatment of water took place at the electrical current of 4-6 A and an inlet flow of 0.6-1.5 m³/hour. The pH value of the catholyte at the outlet of the electrolyzer was 8.0 to 8.4.

Bottling is carried out, corresponding to the amount of payment made by the consumer, into containers made of materials deactivated with respect to hydroxide ions. To maintain constant cleaning and electrolysis parameters, the inlet compartment of the ultrafiltration device and its membranes are cleaned once a month.

### Example 2.1

The implementation of the apparatus for the production and sale of water with pH values from 8.0 to 8.4 was carried out similar to Example 2. But in contrast to this example, a separate line for supplying the catholyte to this compartment was provided between the line for the output of the catholyte from the electrolyzer and the inlet compartment of the ultrafiltration device. and This line is supplied through a pipe provided before the ejector of the ultrafiltration device.

The water entering the apparatus had the following characteristics: pH from 7.8 to 8.2, iron 10-12 mg/l, manganese from 0.30-0.35 mg/l, permanganate oxidation 8-9 mg/l, with the presence of traces of chlorine and organochlorine compounds.

The water at the entrance to the electrolyzer had the following characteristics: pH 7.8-8.2, iron 0.05-0.07 mg/l, manganese 0.010-0.012 mg/l, permanganate oxidation 1.0-1.3 mg/l, with the absence of chlorine and organochlorine compounds. Electrolytic treatment of water took place at a current of 2-3 A and an inlet flow of 0.6-1.5 m³/hour.

The pH value of the catholyte at the outlet of the electrolyzer was between 8.0 and 8.4. Bottling was carried out, corresponding to the amount of payment made by the consumer, into containers made of materials decontaminated with respect to hydroxide ions. To maintain constant cleaning and electrolysis parameters, the inlet compartment of the ultrafiltration device and its membranes are cleaned once every 2 months.

### Example 3

The implementation of the apparatus for obtaining and dispensing water with pH values from 10.5 to 11.0 was carried out similarly to Example 2, but the differential pressure value was 0.55-0.6 MPa.

The water entering the apparatus had the following characteristics: pH 8-8.5, iron 10-12 mg/l, manganese 3-4 mg/l, permanganate oxidation 8-10 mg/l, with the presence of traces of chlorine and organochlorine compounds. The water at the entrance to the electrolyzer had the following characteristics: pH 8-8.5, iron 0.010-0.015 mg/l, manganese 0.04-0.05 mg/dm³, permanganate oxidation 1.0-1.5 mg/l, with absence of chlorine and organochlorine compounds.

Electrolytic treatment of water took place at the electrical current strength of 7-10 A and an inlet flow of 0.1-0.5 m³/hour. The pH value of the catholyte at the outlet of the electrolyzer ranged from 10.5 to 11.0. The catholyte was dispensed at a special window of the apparatus in stainless steel bottles filled by the apparatus.

To maintain constant cleaning and electrolysis parameters, the inlet compartment of the ultrafiltration device and its membranes are cleaned once a month.

### Example 3.1

The implementation of the apparatus for the production and sale of water with pH values from 10.5 to 11.0 was carried out similar to Example 2. However, in contrast to this example, a separate line for supplying the catholyte to the contact container was provided between the line for the output of the catholyte from the electrolyzer and the inlet compartment of the ultrafiltration device. This line connection is supplied through an injector.

The water entering the apparatus had the following characteristics: pH from 8.0 to 8.5, iron from 5 to 7 mg/l, manganese 1.0-1.8 mg/l, permanganate oxidation 6-8 mg/l, with the presence of traces of chlorine and organochlorine compounds. The water at the entrance to the electrolyzer had the following characteristics: pH 8.0-8.5, iron from 0.012-0.015 mg/l, manganese from 0.04-0.05 mg/l, permanganate oxidation from 1 to 2 mg/l, with the absence of chlorine and organochlorine compounds.

Electrolytic treatment of water took place at the electrical current strength of 6-8 A and an inlet flow of 0.1-0.5 m³/hour. The pH value of the catholyte at the outlet of the electrolyzer ranged from 10.5 to 11.0. The catholyte was dispensed in a special window of the apparatus into stainless steel bottles filled in the apparatus.

To maintain constant cleaning and electrolysis parameters, the inlet compartment of the ultrafiltration device and its membranes are cleaned once every 2 months.

The above examples should not be construed as limiting the scope of the invention. On the contrary, variations, modifications and equivalents of the described examples are also possible within the scope of the rights set forth in the claims.

### INDUSTRIAL APPLICABILITY OF THE INVENTION AND ACHIEVEMENT OF A TECHNICAL RESULT

The claimed invention is a technical solution, because represents a solution to the problem of achieving the stated technical result by creating a device consisting of structural elements that are technologically and structurally interconnected. Moreover, the totality of essential features of this invention-a system of devices—is united by a single creative concept.

The parts (elements) of the device are in structural unity and functional interrelation, and their joint use leads to the creation of a new device with a new purpose and function—an apparatus for obtaining and dispensing alkaline water.

This technical solution is industrially applicable in the field of vending machines, namely, vending machines for dispensing purified water with specified properties to consumers. The implementation of the proposed technical solution can be carried out by specialists with appropriate training.

When implementing a apparatus for producing and dispensing alkaline water, devices, instruments and materials that are produced by industry and are publicly available are used. Methods for implementing the invention are methods of mechanical processing of metal and plastics, electric welding and thermal welding of plastics, metalworking, installation.

The means of implementation are mechanical means, apparatus tools and manual machining tools, welding equipment. The use of vending apparatuses for obtaining and dispensing alkaline water is possible for any consumer.

The above set of essential features of the present invention and their disclosure allows the professionals in the field of the invention to conclude that the declared technical result has been achieved. Namely, an increase in the degree of purification of water from organic impurities at the ultrafiltration stage is due to better mixing of the ozone mixture with water, as well as due to better oxidation of organic impurities by ozone in an alkaline environment with the coordinated implementation of these processes. In turn, the implementation of the purpose of the invention is confirmed in view of the following:
obtaining alkaline water with specified parameters by means of the use of an electrolyzer with comprehensive control of the parameters of the water electrolysis process and coordinated regulation of water supply and the electrical current strength, while coordination is carried out according to sensor readings, and changes in water flow and the electrical current strength are carried out by appropriate control devices;
maintaining a predetermined pH level of the catholyte when dispensed to the consumer through portioned dispensing of the catholyte and the selection of dosed portions with the predetermined pH values at the outlet of the electrolyzer; as well as by providing a production line and equipment for dispensing the catholyte from materials deactivated with respect to hydroxide ions. If the pH value at the outlet is exceeded, such values can be normalized to the specified values by diluting with purified water using a bypass line.

The above description of the invention and examples of its implementation confirm the achievement of the declared technical result in the process of implementing the invention. They also show the cause-and-effect relationship of essential features between themselves and the achieved technical result.

From the above description it also follows that achieving a technical result is possible only if the entire set of essential features is implemented, which also confirms the technical solution to the problem of implementing the invention.

### LIST OF REFERENCES

1. Commodity offer “Living Water” [Electronic resource]—https://alivewater.ru/kataloq/apparaty-pitevoi-vodv ( [symbol] aTa o [symbol] pa [symbol] eH [symbol] [symbol] Apr. 1, 2021).
2. Russian Patent No 2495496.
3. Japanese Patent Publication PCT/EP2005/051629.
4. B. F. Kozhinov, I. V. Kozhinov. Ozonization of water. [Electronic resource].—URL: https://helpiks.org/2-71562.html
5. Ozone oxidation. [Electronic resource]-URL: https://ru-ecology.info/term/.
6. Chinese Patent Publication No. 201910570779.3, ny [symbol] Ka [symbol] No 110232780 for: Reduced electrolytic water vending machine for community
7. Russian Patent No 2758347, MΠK G07F13/00, Oct. 11, 2021

1. An apparatus for producing and dispensing alkaline water, comprising: a water treatment unit including a disinfection unit having a recirculation line, an ultrafiltration unit, an ultrafine treatment unit, and a bypass line substantially parallel to a treatment/purification line, said bypass line supplying water with a predetermined degree of purification to an electrolyzer and dispensing water with a predetermined degree of purification;
wherein said apparatus further comprises a water electrolysis unit with a catholyte and anolyte withdrawal outlet capable of setting and maintaining a predetermined value of pH of catholyte, this occurs due to coordinated regulation of the electrolysis process current strength at corresponding devices; as well capable of setting and maintaining a water consumption during separation and selection of a dosed portion of catholyte at the outlet of the electrolyzer, whereby at the outlet of the electrolyzer there is provided a line of anolyte withdrawal and a line of catholyte withdrawal directing the catholyte to a consumer;
said apparatus further comprising a control and monitoring unit having a processor and sensors for monitoring characteristics of the dispensing operation, as well as a catholyte dispensing device, which contains: supply of the dispensing line and the dispensing window for bottling with dispensing and/or dosing and/or partial cutting off equipment, wherein the dispensing line is made of materials deactivated with respect to hydroxydiones; and
at least one window and one line for dispensing water bottles and/or accessories, wherein for the supply of treated water to an inlet compartment of the ultrafiltration device is provided with a water jet ejector, through said ejector an ozone-air mixture for ozonation of the water is provided, from the line of catholyte output from the electrolyzer a separate line extends for supplying the catholyte into the water purification unit with connection to technological elements of said water purification unit before the ultrafiltration device for maintaining alkaline environment in said apparatus.

2. The apparatus according to claim 1, wherein the disinfection device is a contact vessel into which the ozone-air mixture is fed through a water jet ejector.

3. The apparatus according to claim 1, wherein the ultrafiltration device comprises a ceramic filtration membrane with a cut-off threshold of 0.1-0.01 μm.

4. The apparatus according to claim 1, wherein the supply line to the dispensing window, as well as the dispensing and/or dosing equipment are made of stainless steel.

5. The apparatus according to claim 1, wherein the supply line to the dispensing window and the dispensing and/or dosing equipment are made of materials having a deactivated inner surface with respect to hydroxide ions.

6. The apparatus according to claim 1, wherein one window located at the front panel of the dispenser is provided for dispensing water bottles and accessories.

7. The apparatus according to claim 1, wherein additional windows located at the front panel of the dispenser are provided for dispensing water bottles and accessories.

8. The apparatus according to claim 1, wherein the connection of the catholyte supply line to the technological elements of the water treatment unit is selected from the group comprising: an ejector, a spigot and an injector.
